(19) United States
(12) Patent Application Publication
(10) Pub. No.: US 2010/0296850 A1
(43) Pub. Date: Nov. 25, 2010

(54) SHEET INVERTER ADJUSTMENT IN A DUPLEX PRINTER

(76) Inventors: Michael T. Dobbertin, Honeoye, NY (US); Frederick E. Altrieth, III, Scottsville, NY (US)

Correspondence Address: EASTMAN KODAK COMPANY;PATENT LEGAL STAFF, 343 STATE STREET, ROCHESTER, NY, 14650-2201, US

(21) Appl. No.: 12/469,987

(22) Filed: May 21, 2009

(51) Int. Cl. G03G 15/00

(52) U.S. Cl. 399/364

(57) ABSTRACT

A method and related apparatus for inverting receivers in a plurality of physically coupled print engines by using an inverter such that one or more images are digitally printed on designated receiver sheets whereby all receiver sheets that can be inverted are inverted and those that cannot be inverted are not inverted. A skip frame is added to the first print engine preceding each noninvertible receiver sheets.

### FIELD OF INVENTION

This invention pertains to a method to optimize productivity for a duplex print engine when printing a mixture of one sided and two sided prints. In particular, this invention relates to a digital print engine comprising a plurality of coupled print engines and at least one inverter to invert receiver sheets coupled between at least two of the print engines.

### BACKGROUND OF THE INVENTION

In typical commercial reproduction apparatus (electrographic copier/duplicators, printers, or the like), a latent image charge pattern is formed on a primary imaging member (PIM) such as a photoreceptor used in an electrophotographic printing apparatus. While the latent image can be formed on a dielectric PIM by depositing charge directly corresponding to the latent image, it is more common to first uniformly charge a photoreceptive PIM member. The latent image is then formed by area-wise exposing the PIM in a manner corresponding to the image to be printed. The latent image is rendered visible by bringing the primary imagine member into close proximity to a development station. A typical development station may comprise a cylindrical magnetic core and a coaxial nonmagnetic shell. In addition, a sump may be present containing developer which comprises marking particles, typically comprising a colorant such as a pigment, a thermoplastic binder, one or more charge control agents, and flow and transfer aids such as submicrometer particles adhered to the surface of the marking particles. The submicrometer particles typically comprise silica, titania, various latices, etc. The developer typically also comprises magnetic carrier particles such as ferrite particles that tribocharge the marking particles and transport the marking particles into close proximity to the PIM, thereby allowing the marking particles to be attracted to the electrostatic charge pattern corresponding to the latent image on the PIM, thereby rendering the latent image into a visible image.

The shell of the development station is typically electrically conducting and can be electrically biased so as to establish a desired difference of potential between the shell and the PIM. This, together with the electrical charge on the marking particles, determines the maximum density of the developed print for a given type of marking particle.

The image developed onto the PIM member is then transferred to a suitable receiver such as paper or other suitable substrate. This is generally accomplished by pressing the receiver into contact with the PIM member while applying a voltage to urge the marking particles towards the receiver. Alternatively, the image can be transferred from the primary imaging member to a transfer intermediate member (TIM) and then from the TIM to the receiver.

The image is then fixed to the receiver by fusing, typically accomplished by subjecting the image bearing receiver to a combination of heat and pressure. The PIM and TIM, if used, are cleaned and made ready for the formation of another print.

The image is then fixed to the receiver by fusing, typically accomplished by subjecting the image bearing receiver to a combination of heat and pressure. The PIM and TIM, if used, are cleaned and made ready for the formation of another print.

A reproduction apparatus generally is designed to generate a specific number of prints per minute. For example, a printer may be able to generate 150 single-sided pages per minute (ppm) or approximately 75 double-sided pages per minute with an appropriate duplexing technology. Small upgrades in system throughput may be achievable in robust printing systems, however, the doubling of throughput speed is mainly unachievable without a) purchasing a second reproduction apparatus with throughput identical to the first so that the two machines may be run in parallel, or without b) replacing the first reproduction apparatus with a radically redesigned print engine having double the speed. Both options are very expensive and often with regard to option (b), not possible.

Another option for increasing reproduction apparatus throughput is to utilize a second print engine in series with a first print engine. For example, U.S. Pat. No. 7,245,856 discloses a tandem printing system which is configured to reduce image registration errors between a first side image formed by a first print engine and a second side image formed by a second print image. Each of the '856 print engines has a photoconductive belt having a seam. The seams of the photoconductive belt in each print engine are synchronized by tracking a phase difference between seam signals from both belts. Synchronization of a slave print engine to a main print engine occurs once per revolution of the belts, as triggered by a belt seam signal, and the velocity of the slave photoreceptor and the velocity of an imager motor and polygon assembly are updated to match the velocity of the master photoreceptor. Unfortunately, such a system tends to be susceptible to increasing registration errors during each successive image frame during the photoreceptor revolution. Furthermore, given the large inertia of the high-speed rotating polygon assembly, it is difficult to make significant adjustments to the velocity of the polygon assembly in the relatively short time frame of a single photoreceptor revolution. This can limit the response of the '856 system on a per revolution basis, and make it even more difficult, if not impossible, to adjust on a more frequent basis.

Color images are made by printing separate images corresponding to an image of a specific color. The separate images are then transferred, in register, to the receiver. Alternatively, they can be transferred in register to a TIM and from the TIM to the receiver or they may be transferred separately to a TIM and then transferred and registered on the receiver. For example, a printing engine capable of producing full color images may comprise at least four separate engines, each engine printing prints corresponding to the subtractive primary color cyan, magenta, yellow, and black. Additional development stations may comprise marking particles of additional colorants to expand the obtainable color gamut, clear toner, etc., as are known in the art.

In a typical digital printing engine comprising a plurality of coupled print engines and at least one inverter to invert receiver sheets so as to allow duplex printing, inverting the sheets can present productivity problems. Often, in order to minimize the speeds in the inverter and maximize the timing compensation latitude (by varying the inverter dwell time), the frame synchronization offset between the first and second marking engines are different for invert and non-invert modes. This would require the print engine to be repeatedly synchronized, which would adversely affect the process speed. For this reason, it is advantageous to invert all sheets in a mixed mode job, printing “blank” backs on the simplex sheets. In this manner, the press can operate at full speed rather than adding skip frames or re-synchronizing with a different offset when switching between simplex and duplex. This also has two other advantages. First, receivers that have a “front/back”, such as pre-printed materials or letterhead, or a “left/right” side such as pre-punched stock are loaded in the paper supply in the same orientation for both simplex and duplex prints. Second, any background printed from the first engine is placed on the back of the sheet rather than the front where the desired image is.

### SUMMARY OF THE INVENTION

This invention describes a process and apparatus for digitally printing images on receiver sheets whereby all receiver sheets that can be inverted are inverted and those that cannot be inverted are not inverted. A skip frame is added to the first print engine preceding each noninvertible receiver sheet.

### BRIEF DESCRIPTION OF THE DRAWINGS

FIG. 1 schematically illustrates an embodiment of an electrophotographic print engine.

FIG. 2 schematically illustrates an embodiment of a reproduction apparatus having a first print engine.

FIGS. 3A-3C schematically illustrate embodiments of a reproduction apparatus having a first print engine and a tandem second print engine from a productivity module.

FIG. 4 schematically illustrates an embodiment of a reproduction or printing apparatus having embodiments of a first and second print engines.

FIG. 5 schematically illustrates a time shot of a photoconductor showing the placement of six receiver sheets.

FIG. 6 schematically illustrates the lookup table designating the sheets as invertible and noninvertible receiver sheets.

FIG. 7 schematically illustrates a flow chart showing the sequence of print engine operations for invertible and noninvertible receiver sheets.

### DETAILED DESCRIPTION OF THE INVENTION

This invention pertains to a method to maximize the productivity of a digital print engine, preferably an electrophotographic digital print engine comprising a plurality of coupled electrophotographic print engines and at least one inverter capable of inverting receiver sheets that is coupled between two of the electrophotographic print engines.

Many applications in printing, especially digital printing and more particularly electrophotographic printing require that multiple print engines be sequentially ganged together to maximize printing efficiency. For example, as described in patent applications Ser. Nos. 12/126,192 and 12/126,267, an electrophotographic printer can comprise two similar print engines that have been coupled together. A module termed a productivity module inverts the receiver sheets between the coupled modules, thereby allowing the production of duplex images to be formed on a receiver at the full process speed of an individual module, effectively doubling productivity.

To maximize printing efficiency and speed, the smallest frame size possible is generally chosen for a given size receiver. As described in patent applications Ser. Nos. 12/126,192 and 12/126,167, for coupled print engine configurations, the image frames for a slave print engine must be synchronized to those in the master print engine so that sheets are delivered from to the slave engine at the correct time for a specific image frame. As described in patent application Ser. No. 12/128,897, the image frames must also be delayed to allow for the time required for the receiver to travel from the image transfer location in one engine to the corresponding location in the second engine.

In some applications, as previously discussed, a digital print engine comprises two coupled printing modules separated by an inverter that flips the paper between the modules so that the second print engine forms a print on the reverse side of the receiver from that formed by the first print engine. For such applications, the inverter would have to transport the receiver at a high enough velocity to invert the longest receiver in the time normally allotted for inversion in the smallest image frame size mode if the same delay or temporal offset were used for all paper sizes. Because both the time to invert sheets and the time allotted for the corresponding image frames increase with receiver/image frame size, the optimum timing offset increases with image frame size. By intentionally defining different offsets for each frame mode, the inverter speed can be minimized without unduly compromising timing latitude. In other words, the timing latitude can be maximized for a given inverter speed.

The aforementioned patent applications disclose a method of synchronizing a slave print engine to a master by adjusting the appropriate print engine speed to achieve a consistent temporal offset between frame markers on the photoreceptors of the two print engines. According to these applications, the frame markers are physical markings such as perforations, splices, etc. If multiple frame modes are desired, it would be necessary to add additional markings for each frame of each mode. This is not desirable and, in some configurations such as when the PIM comprises a photoreceptive drum rather than a web, this is not even feasible.

The optimum timing offset is a function of the time required to transport the receiver from the image transfer location in the first print engine that in the second print engine. As the timing offset can vary from printer to printer due to drive roller tolerances, the length or circumference of the photoreceptor, the paper path length, and engine to engine mating variations, it is necessary to provide a means to determine and set the required offset by a field engineer on the specific print engines. This is even more problematic when one is upgrading an existing single module print engine with a second print engine and, perhaps, even an inverter.

This invention describes a simple and direct method of achieving this. In this invention, the offset is set to a value corresponding to that for the smallest image frame size. Printing is initiated and the sheet arrival time is measured at a convenient point such as a registration or image transfer point. In order to minimize variability in this measurement, the sheets are directed in the non-invert path and the arrival time at the optical sensor in the Pre-Registration Assembly is measured relative to the slave engine image frame marker (F-Perf). The average arrival time for a number of sheets is compared to the target arrival time. The target arrival time is defined as the nominal arrival time of the lead edge of the receiver sheet at a specified location in a print engine such as the aforementioned optical sensor. The synchronization offset is then adjusted accordingly so that the synchronization is optimized. Because the vast majority of the timing variability that needs to be calibrated is common for all frame modes, this service program is only run for the most stringent frame mode and that correction is applied to all modes. As this invention does not invert the sheets, it is suitable, not only for the case of coupled single color print engines separated by an inverter, but for other print engines such as color print engines whereby color prints corresponding to the separate colors comprising the finished print are produced on separate engines and registered either on an intermediate member or on the receiver.

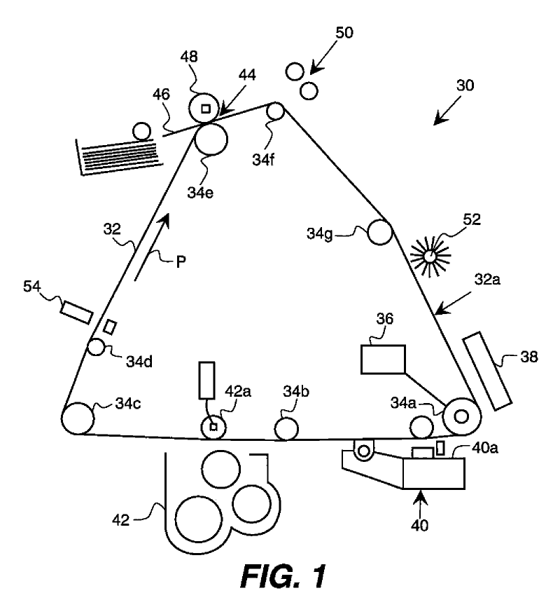

FIG. 1 schematically illustrates an embodiment of an electrophotographic print engine 30. The print engine 30 has a movable recording member such as a photoreceptive belt 32, which is entrained about a plurality of rollers or other supports 34a through 34g. The photoreceptive belt 32 may be more generally referred-to as a primary imaging member (PIM) 32. A primary imaging member (PIM) 32 may be any charge carrying substrate which may be selectively charged or discharged by a variety of methods including, but not limited to corona charging/discharging, gated corona charging/discharging, charge roller charging/discharging, ion writer charging, light discharging, heat discharging, and time discharging.

One or more of the rollers 34a-34g are driven by a motor 36 to advance the PIM 32. Motor 36 preferably advances the PIM 32 at a high speed, such as 20 inches per second or higher, in the direction indicated by arrow P, past a series of workstations of the print engine 30, although other operating speeds may be used, depending on the embodiment. In some embodiments, PIM 32 may be wrapped and secured about only a single drum. In further embodiments, PIM 32 may be coated onto or integral with a drum.

The term module means a device or subsystem designed to perform a specific task in producing a printed image. For example, a development module in an electrophotographic printer would include a primary imaging member (PIM) such as a photoreceptive member and one or more development stations that would image-wise deposit marking or toner particles onto an electrostatic latent image on the PIM, thereby rendering it into a visible image. A module can be an integral component in a print engine. For example, a development module is usually a component of a larger assembly that includes writing transfer and fuser modules such as are known in the art. Alternatively, a module can be self contained and can be made in a manner so that they are attached to other modules to produce a print engine. Examples of such modules include scanners, glossers, inverters that will invert a sheet of paper or other receiver to allow duplex printing, inserters that allow sheets such as covers or preprinted receivers to be inserted into documents being printed at specific locations within a stack of printed receiver sheets, and finishers that can fold, stable, glue, etc. the printed documents.

A print engine includes sufficient modules to produce prints. For example, a black and white electrophotographic print engine would generally include at least one development module, a writer module, and a fuser module. Scanner and finishing modules can also be included if called for by the intended applications.

A print engine assembly, also referred to in the literature as a reproduction apparatus, includes a plurality of print engines that have been integrally coupled together in a manner to allow them to print in a desired manner. For example, print engine assemblies that include two print engines and an inverter module that are coupled together to increase productivity by allowing the first print engine to print on one side of a receiver, the receiver then fed into the inverter module which inverts the receiver and feeds the receiver into the second print engine that prints on the inverse side of the receiver, thereby printing a duplex image.

A digital print engine is a print engine wherein the image is written using digital electronics. Such print engines allow the image to be manipulated, image by image, thereby allowing each image to be changed. In contrast, an offset press relies on the image being printed using press plates. Once the press plate is made, it cannot be changed. An example of a digital print engine is an electrophotographic print engine wherein the electrostatic latent image is formed on the PIM by exposing the PIM using a laser scanner or LED array. Conversely, an electrophotographic apparatus that relies on forming a latent image by using a flash exposure to copy an original document would not be considered a digital print engine.

A digital print engine assembly is a print engine assembly that a plurality of print engines of which at least one is a digital print engine.

Contrast is defined as the maximum value of the slope curve of the density versus log of the exposure. The contrast of two prints is considered to be equal if they differ by less than 0.2 ergs/cm² and preferably by less than 0.1 ergs/cm².

Print engine 30 may include a controller or logic and control unit (LCU) (not shown). The LCU may be a computer, microprocessor, application specific integrated circuit (ASIC), digital circuitry, analog circuitry, or a combination or plurality thereof The controller (LCU) may be operated according to a stored program for actuating the workstations within print engine 30, effecting overall control of print engine 30 and its various subsystems. The LCU may also be programmed to provide closed-loop control of the print engine 30 in response to signals from various sensors and encoders. Aspects of process control are described in U.S. Pat. No. 6,121,986 incorporated herein by this reference.

A primary charging station 38 in print engine 30 sensitizes PIM 32 by applying a uniform electrostatic corona charge, from high-voltage charging wires at a predetermined primary voltage, to a surface 32a of PIM 32. The output of charging station 38 may be regulated by a programmable voltage controller (not shown), which may in turn be controlled by the LCU to adjust this primary voltage, for example by controlling the electrical potential of a grid and thus controlling movement of the corona charge. Other forms of chargers, including brush or roller chargers, may also be used.

An image writer, such as exposure station 40 in print engine 30, projects light from a writer 40a to PIM 32. This light selectively dissipates the electrostatic charge on photoreceptive PIM 32 to form a latent electrostatic image of the document to be copied or printed. Writer 40a is preferably constructed as an array of light emitting diodes (LEDs), or alternatively as another light source such as a Laser or spatial light modulator. Writer 40a exposes individual picture elements (pixels) of PIM 32 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

After exposure, the portion of PIM 32 bearing the latent charge images travels to a development station 42. Development station 42 includes a magnetic brush in juxtaposition to the PIM 32. Magnetic brush development stations are well known in the art, and are preferred in many applications; alternatively, other known types of development stations or devices may be used. Plural development stations 42 may be provided for developing images in plural gray scales, colors, or from toners of different physical characteristics. Full process color electrographic printing is accomplished by utilizing this process for each of four toner colors (e.g., black, cyan, magenta, yellow).

Upon the imaged portion of PIM 32 reaching development station 42, the LCU selectively activates development station 42 to apply toner to PIM 32 by moving backup roller 42a and PIM 32, into engagement with or close proximity to the magnetic brush. Alternatively, the magnetic brush may be moved toward PIM 32 to selectively engage PIM 32. In either case, charged toner particles on the magnetic brush are selectively attracted to the latent image patterns present on PIM 32, developing those image patterns. As the exposed photoreceptor passes the developing station, toner is attracted to pixel locations of the photoreceptor and as a result, a pattern of toner corresponding to the image to be printed appears on the photoreceptor. As known in the art, conductor portions of development station 42, such as conductive applicator cylinders, are biased to act as electrodes. The electrodes are connected to a variable supply voltage, which is regulated by a programmable controller in response to the LCU, by way of which the development process is controlled.

Development station 42 may contain a two-component developer mix, which comprises a dry mixture of toner and carrier particles. Typically the carrier preferably comprises high coercivity (hard magnetic) ferrite particles. As a non-limiting example, the carrier particles may have a volume-weighted diameter of approximately 30μ. The dry toner particles are substantially smaller, on the order of 6μ to 15μ in volume-weighted diameter. Development station 42 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to PIM 32 to develop the electrostatic images thereon and the carrier material remains at development station 42. As toner is depleted from the development station due to the development of the electrostatic image, additional toner may be periodically introduced by a toner auger (not shown) into development station 42 to be mixed with the carrier particles to maintain a uniform amount of development mixture. This development mixture is controlled in accordance with various development control processes. Single component developer stations, as well as conventional liquid toner development stations, may also be used.

A transfer station 44 in printing machine 10 moves a receiver sheet 46 into engagement with the PIM 32, in registration with a developed image to transfer the developed image to receiver sheet 46. Receiver sheets 46 may be plain or coated paper, plastic, or another medium capable of being handled by the print engine 30. Typically, transfer station 44 includes a charging device for electrostatically biasing movement of the toner particles from PIM 32 to receiver sheet 46. In this example, the biasing device is roller 48, which engages the back of sheet 46 and which may be connected to a programmable voltage controller that operates in a constant current mode during transfer. Alternatively, an intermediate member may have the image transferred to it and the image may then be transferred to receiver sheet 46. After transfer of the toner image to receiver sheet 46, sheet 46 is detacked from PIM 32 and transported to fuser station 50 where the image is fixed onto sheet 46, typically by the application of heat and/or pressure. Alternatively, the image may be fixed to sheet 46 at the time of transfer.

A cleaning station 52, such as a brush, blade, or web is also located beyond transfer station 44, and removes residual toner from PIM 32. A pre-clean charger (not shown) may be located before or at cleaning station 52 to assist in this cleaning. After cleaning, this portion of PIM 32 is then ready for recharging and re-exposure. Of course, other portions of PIM 32 are simultaneously located at the various workstations of print engine 30, so that the printing process may be carried out in a substantially continuous manner.

A controller provides overall control of the apparatus and its various subsystems with the assistance of one or more sensors, which may be used to gather control process, input data. One example of a sensor is belt position sensor 54.

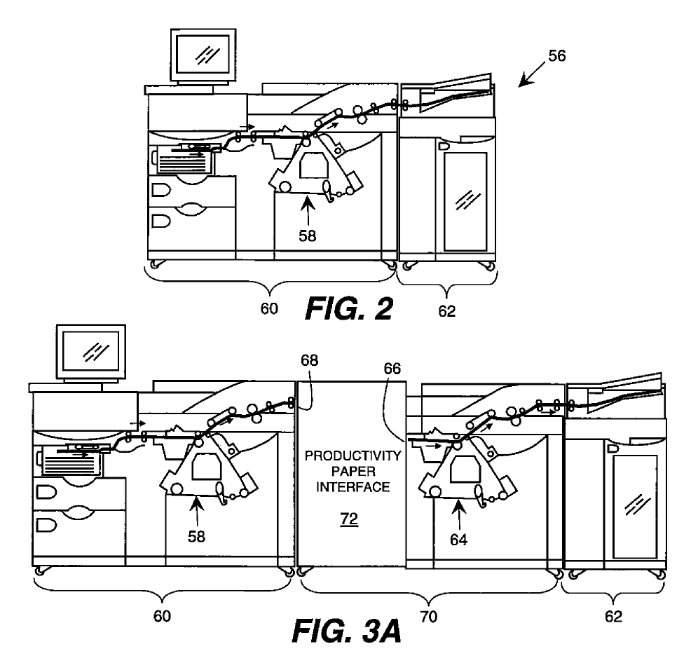

FIG. 2 schematically illustrates an embodiment of a reproduction apparatus 56 having a first print engine 58. The embodied reproduction apparatus will have a particular throughput, which may be measured in pages per minute (ppm). As explained above, it would be desirable to be able to significantly increase the throughput of such a reproduction apparatus 56 without having to purchase an entire second reproduction apparatus. It would also be desirable to increase the throughput of reproduction apparatus 56 without having to scrap apparatus 56 and replacing it with an entire new machine.

Quite often, reproduction apparatus 56 is made up of modular components. For example, the print engine 58 is housed within a main cabinet 60 that is coupled to a finishing unit 62. For simplicity, only a single finishing device 62 is shown, however, it should be understood that multiple finishing devices providing a variety of finishing functionality are known to those skilled in the art and may be used in place of a single finishing device. Depending on its configuration, the finishing device 62 may provide stapling, hole punching, trimming, cutting, slicing, stacking, paper insertion, collation, sorting, and binding.

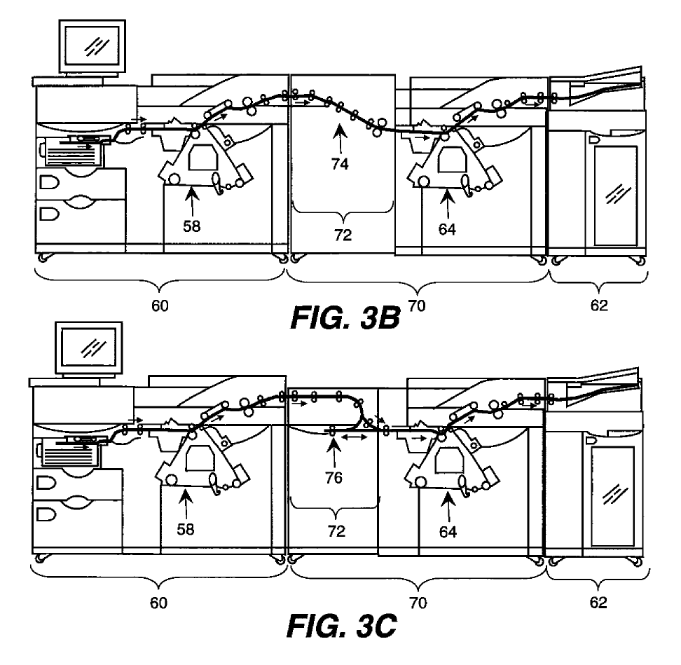

As FIG. 3A schematically illustrates, a second print engine 64 may be inserted in-line with the first print engine 58 and in-between the first print engine 58 and the finishing device 62 formerly coupled to the first print engine 58. The second print engine 64 may have an input paper path point 66 which does not align with the output paper path point 68 from the first print engine 58. Additionally, or optionally, it may be desirable to invert the receiver sheets from the first print engine 58 prior to running them through the second print engine (in the case of duplex prints). In such instances, the productivity module 70 which is inserted between the first print engine 58 and the at least one finisher 62 may have a productivity paper interface 72. Some embodiments of a productivity paper interface 72 may provide for matching 74 of differing output and input paper heights, as illustrated in the embodiment of FIG. 3B. Other embodiments of a productivity paper interface 72 may provide for inversion 76 of receiver sheets, as illustrated in the embodiment of FIG. 3C.

Providing users with the option to re-use their existing equipment by inserting a productivity module 70 between their first print engine 58 and their one or more finishing devices 62 can be economically attractive since the second print engine 64 of the productivity module 70 does not need to come equipped with the input paper handling drawers coupled to the first print engine 58. Furthermore, the second print engine 64 can be based on the existing technology of the first print engine 58 with control modifications which will be described in more detail below to facilitate synchronization between the first and second print engines.

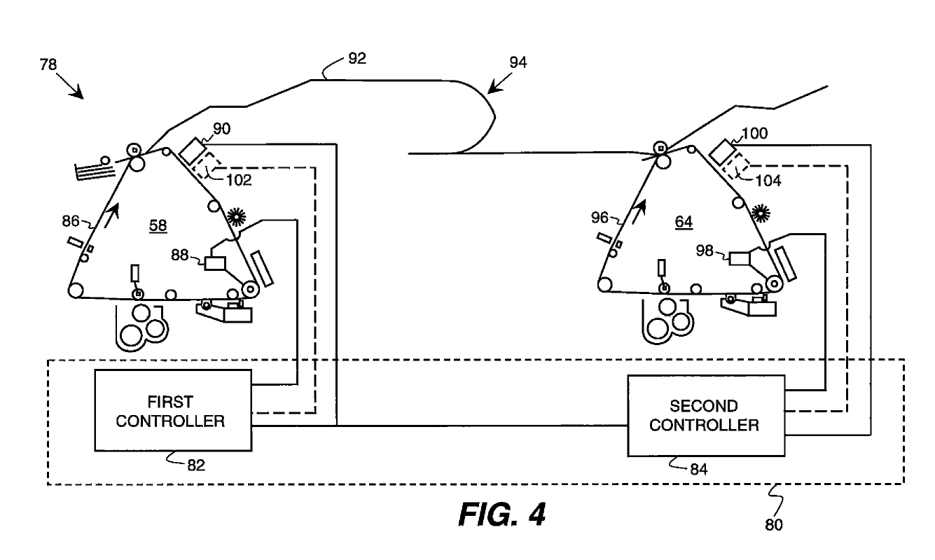

FIG. 4 schematically illustrates an embodiment of a reproduction apparatus 78 having embodiments of first and second print engines 58, 64 which are synchronized by a controller 80. Controller 80 may be a computer, a microprocessor, an application specific integrated circuit, digital circuitry, analog circuitry, or any combination and/or plurality thereof. In this embodiment, the controller 80 includes a first controller 82 and a second controller 84. Optionally, in other embodiments, the controller 80 could be a single controller as indicated by the dashed line for controller 80. The first print engine 58 has a first primary imaging member (PIM) 86, the features of which have been discussed above with regard to the PIM of FIG. 1. The first PIM 86 also preferably has a plurality of frame markers corresponding to a plurality of frames on the PIM 86. In some embodiments, the frame markers may be holes or perforations in the PIM 86 which an optical sensor can detect. In other embodiments, the frame markers may be reflective or diffuse areas on the PIM, which an optical sensor can detect. Other types of frame markers will be apparent to those skilled in the art and are intended to be included within the scope of this specification. The first print engine 58 also has a first motor 88 coupled to the first PIM 86 for moving the first PIM when enabled. As used here, the term “enabled” refers to embodiments where the first motor 88 may be dialed in to one or more desired speeds as opposed to just an on/off operation. Other embodiments, however, may selectively enable the first motor 88 in an on/off fashion or in a pulse-width-modulation fashion.

The first controller 82 is coupled to the first motor 88 and is configured to selectively enable the first motor 88 (for example, by setting the motor for a desired speed, by turning the motor on, and/or by pulse-width-modulating an input to the motor). A first frame sensor 90 is also coupled to the first controller 82 and configured to provide a first frame signal, based on the first PIM's plurality of frame markers, to the first controller 82.

A second print engine 64 is coupled to the first print engine 58, in this embodiment, by a paper path 92 having an inverter 94. The second print engine 64 has a second primary imaging member (PIM) 96, the features of which have been discussed above with regard to the PIM of FIG. 1. The second PIM 96 also preferably has a plurality of frame markers corresponding to a plurality of frames on the PIM 96. In some embodiments, the frame markers may be holes or perforations in the PIM 96, which an optical sensor can detect. In other embodiments, the frame markers may be reflective or diffuse areas on the PIM which an optical sensor can detect. Other types of frame markers will be apparent to those skilled in the art and are intended to be included within the scope of this specification. The second print engine 64 also has a second motor 98 coupled to the second PIM 96 for moving the second PIM 96 when enabled. As used here, the term “enabled” refers to embodiments where the second motor 98 may be dialed in to one or more desired speeds as opposed to just an on/off operation. Other embodiments, however, may selectively enable the second motor 98 in a pulse-width-modulation fashion.

The second controller 84 is coupled to the second motor 98 and is configured to selectively enable the second motor 98 (for example, by setting the motor for a desired speed, or by pulse-width-modulating an input to the motor). A second frame sensor 100 is also coupled to the second controller 84 and configured to provide a second frame signal, based on the second PIM's plurality of frame markers, to the second controller 84. The second controller 84 is also coupled to the first frame sensor 90 either directly as illustrated or indirectly via the first controller 82 which may be configured to pass data from the first frame sensor 90 to the second controller 84.

While the operation of each individual print engine 58 and 64 has been described on its own, the second controller 84 is also configured to synchronize the first and second print engines 58, 64 on a frame-by-frame basis. Optionally, the second controller 84 may also be configured to synchronize a first PIM splice seam from the first PIM 86 with a second PIM splice seam from the second PIM 96. In the embodiments that synchronize the PIM splice seams, the first print engine 58 may have a first splice sensor 102 and the second print engine 64 may have a second splice sensor 104. In other embodiments, the frame sensors 90, 100 may be configured to double as splice sensors.

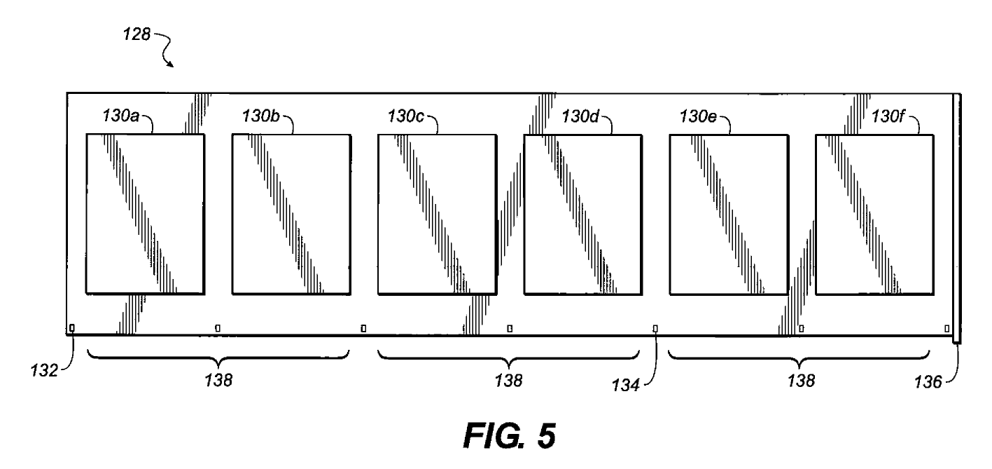

FIG. 5 shows a sketch of time shot 128 that shows the placement of six sheets 130a-f frame markers 134, and a marker 132 to mark a splice or similar non-printable area 134 as well as another non-printable area seam 136. These sheets in the embodiment discussed above were designated as sheet pairs 138.

While one embodiment describes a process for a duplex single color engine, the concept is readily extendable to a digital print engine comprising a plurality of print engines. For example, a series of 4 coupled print engines comprising cyan, magenta, yellow, and black printing engines can print side 2 of the receiver sheet. The receiver sheet is then inverted, if invertible, and fed into print engines 5-8 where side 1 is printed.

While this method is preferred in most cases, there are certain types of receivers that it is undesirable to invert. For instance, discrete cut tabs, labels, and transparencies or single photo paper, such as a cover. One way to account for this is to provide a field in the paper catalog for “one sided receivers”. If this field is designated, the sheet will never be inverted and the skip frame(s) will be added to allow for this mixed mode occurrence. Since this is relatively infrequent, it is desirable to treat it as a special case rather than penalize all other mixed mode jobs. If desired, the option can be provided to disable the “mixed mode productivity enhancement” for all jobs as a configurable setting.

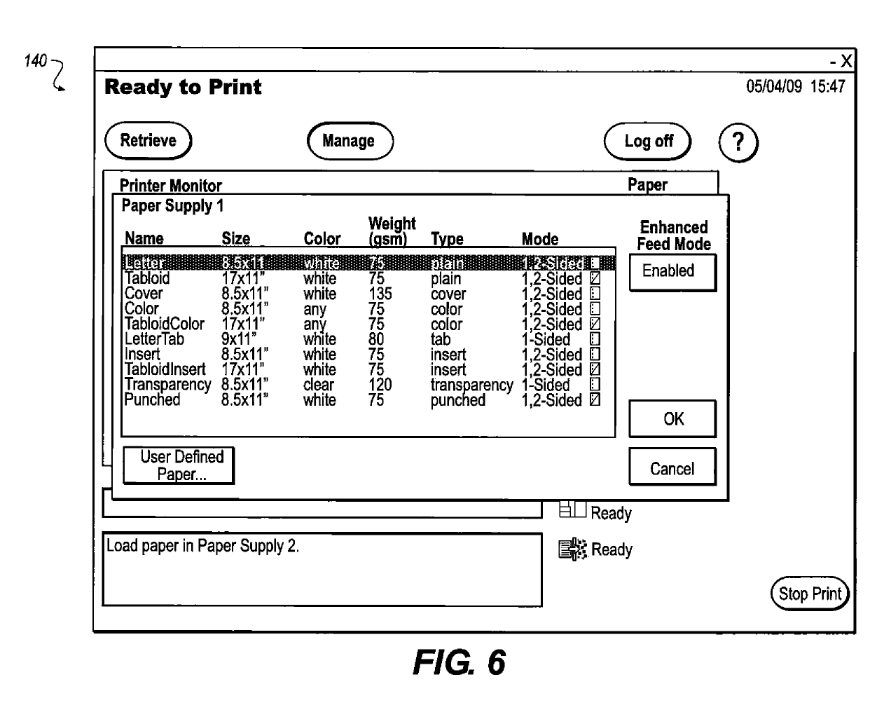

In one embodiment of this invention, the control module for the digital print engine contains a lookup table listing sheets, as shown in FIG. 6, that are noninvertible. When an operator lists the receiver sheets being used, the lookup table 140 designates the sheets as noninvertible. The lookup table can list invertible sheets and, by default, designate all other sheets as noninvertible. Alternatively, the operator can input into the processing unit whether a specified receiver sheet is invertible or noninvertible. Alternatively, noninvertible sheets can be fed into the print engine in an inserter that is coupled to the digital print engine to insert noninvertible receiver sheets that are to be printed after the inverter. Alternatively, the operator can designate a mode of operation where there is no single sided sheet to be inverted, even if it is designated a invertible sheet or receiver. This override default is achieved by disabling the productivity enhancement option. The ability to disable the productively enhancement option is especially useful for old, or legacy, jobs that were set up before the enhancement option was available since these jobs would not have been set-up or designated as jobs with “simplex” sheets rather than designating the receiver as a one sided receiver and thus the method might not handle them properly. This override also works for jobs that come from other software setups that would not otherwise be compatible.

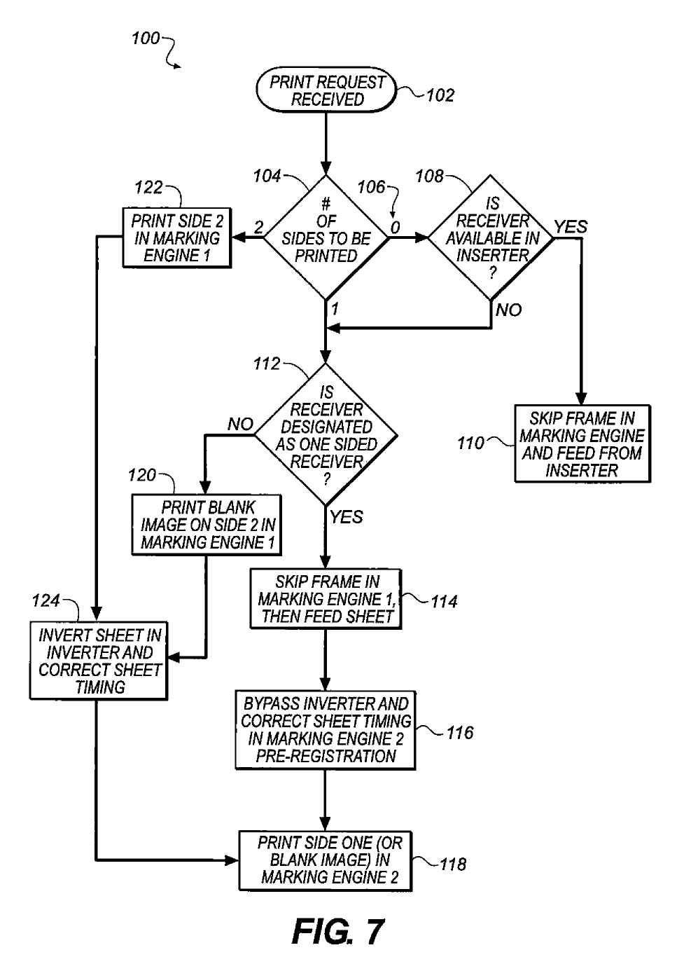

FIG. 7 shows a schematic of how the present invention operates in one preferred mode of operation comprising two black and white print engines coupled to each other through an inverter. While this discussion focuses on this preferred mode of operation, it is clear that it equally applies to other applications. For example, the present invention equally well applies to a print engine comprising a plurality of engines such as a color engine whereby full color prints are produced by separately printing on separate engines those colors comprising the subtractive primary colors cyan, magenta, yellow, and black. The present invention also applies to a series of coupled print engines comprising a plurality of print engines, each of which prints a different color on one side of a receiver, inverts the receiver, and an additional plurality of printers prints an image on the second side of the receiver.

In the method of inverting a sheet or receiver based on receiver type 100 a print request for a print job is received 102 by the control unit of the first print engine, as diagrammed in FIG. 7. The job specifies for each receiver sheet whether 0, 1, or 2 sides are to be printed 104. If zero sides of the receiver are to be printed 106, the receiver sheet is preferably placed into a device commonly referred to as an inserter 108, which is designed to insert sheets that are not printed in the present engine into a specified location in the receiver sheets that had been printed. This can lead to a skip frame 110. The inserter is coupled to the digital printing press after the last of the plurality of coupled marking engines.

If the digital print engine does not comprise an inserter, the receiver sheet that has zero sides to be printed is treated the same as a sheet that has one side printed 112, except that no image is printed on either side. If it is designated as a one side receiver, a skip frame is then inserted into print engine 1 and the receiver sheet is fed into print engine 1 after the skip frame, which then does not print on side 2 of the receiver 114. The sheet bypasses the inverter and is fed into engine 2, where, if necessary, the timing of the sheet is corrected to synchronize it with print engine 2 based on the frame timing marker 116. No printing on side 1 of the receiver is done by print engine 2 118. If the receiver is not designated as a one sided receiver, it is fed into print engine 1 (without a skip frame) which then does not print on side 2 of the receiver 120. The sheet is inverted and fed into engine 2 at the appropriate time based on the frame timing marker, and a blank image is printed on side 1 of the receiver.

If the receiver has been designated as a noninvertible receiver and is to receive printing, a skip frame is then inserted into print engine 1 and the receiver sheet is fed into print engine I after the skip frame, which then does not print on side 2 of the receiver. The sheet bypasses the inverter and is fed into engine 2, where, if necessary, the timing of the receiver is adjusted based on the frame timing marker of print engine. Side 1 of the receiver is printed by print engine 2 118.

If the receiver has been designated as an invertible receiver, it is first fed into print engine 1 where side 2 is printed. If side 2 is not to be printed, the receiver sheet simply does not receive any printing. The sheet is then inverted. The receiver sheet is then fed from the inverter into print engine 2 based on the frame timing marker where side 1 is printed 124. It is clear that a receiver could be designated as invertible or not invertible. Simply for purposes of clarity in the claimed invention the terms designated will be used to designate receivers that are to be inverted and non-designated as those receivers designated to not be inverted. It would be clear to one skilled in the art that these terms could just as easily meant the other and is not meant to limit the application in any way.

The above described method for printing and inverting sheets in a plurality of physically coupled print engines includes printing a first image, which may be a blank image or no image at all, on a first surface of one or more receivers using a first print engine such that the one or more designated receivers are capable of being inverted, feeding a first designated receiver of the one or more designated receivers into an inverter that is functionally coupled to the first print engine to invert the first designated receiver, then feeding the first designated receiver from the inverter into a second print engine that is functionally coupled to the inverter; and repeating the above step for each of the one or more designated receivers so that any non-designated receivers are not inverted and the one or more designated receivers that have been inverted are inverted receivers. A second image, which may be a blank image or no image at all, can be printed on a second side of one or more inverted receivers and on top of the first image on the first side on any receiver that has not been inverted. The second side of the designated receivers is printed in engine 1 and then inverted by an inverter in one embodiment and the inverted receiver is fed from the inverter to engine 2 before side one of the inverted receiver is printed in engine 2. The print engine, in one embodiment, can determine the one or more designated receivers using a look up table. An operator can also add a designation to determine the one or more designated receivers. One or more skip frames can be added prior to printing the non-inverted receivers. In one example the designated receiver is further designated to be printed only on side one, a skip frame is inserted into print engine 1 before the designated receiver is fed into print engine 1 and on into print engine 2 thereby bypassing the inverter so that side one of the designated receivers is printed in print engine 2.

The invention has been described in detail with particular reference to certain preferred embodiments thereof, but it will be understood that variations and modifications can be effected within the spirit and scope of the invention.

What is claimed is:

1. A method for printing and inverting sheets in a plurality of physically coupled print engines such that a one or more designated receivers are capable of being inverted, the method comprising:
a. printing a first image on a first surface of one or more receivers using a first print engine;
b. feeding a first designated receiver of one or more designated receivers into an inverter that is functionally coupled to the first print engine to invert the first designated receiver;
c. feeding the first designated receiver from the inverter into a second print engine that is functionally coupled to the inverter; and
d. repeating the above steps for each of the one or more designated receivers so that any non-designated receivers-are not inverted.

2. The method according to claim 1 further comprising printing a second image on top of the first image on a second side of one or more inverted receivers

3. The method according to claim 1 further comprising printing a second image on the first side of any non-designated receiver that has not been inverted.

4. The method according to claim 1 further comprising not printing a second image on top of the first image on a second side of one or more inverted receivers

5. The method according to claim 1 further comprising not printing a second image on the first side of any non-designated receiver that has not been inverted.

6. The method according to claim 1 whereby side two of the inverted receiver is printed in print engine 1.

7. The method according to claim 1 whereby side two of of the designated receivers-is printed in engine 1 and then inverted by an inverter;
the inverted receiver is fed from the inverter to engine 2;
side one of the inverted receiver is printed in engine 2.

8. The method according to claim 1 whereby the print engine determines the one or more designated receivers using a look up table.

9. The method according to claim 8 further comprising an operator adding an designation to determine the one or more designated receivers.

10. The method according to claim 1 further comprising adding a skip frame after printing inverted receivers.

11. The method according to claim 10 whereby:
a designated receiver is further designated to be printed only on side one;
a skip frame is inserted into print engine 1;
the designated receiver is fed into print engine 1;
the designated receiver is fed from print engine 1 to print engine 2 bypassing the inverter;
Side one of the designated receivers is printed in print engine 2.

12. The method according to claim 1 whereby a receiver sheet that will not be imaged is fed into the job using an inserter.

13. The method according to claim 1 whereby one or more of the images are blank.

14. The method according to claim 1 further comprising an override whereby any sheets with an image on only one side of the designated receiver are treated as a non-designated receiver and thus are treated as non-invertible

15. An electrophotographic printer for printing and inverting sheets in a plurality of physically coupled print engines such that a one or more designated receivers are capable of being inverted, the apparatus comprising:
a plurality of coupled electrophotographic engines for printing a first image on a first surface of one or more receivers using a first print engine;
an inverter functionally coupled to the first print engine to invert the first designated receiver for inverting one or more designated receivers;
a feeder for feeding a first designated receiver of the one or more designated receivers into the inverter and from the inverter into a second print engine that is also functionally coupled to the inverter; and
a controller for inserting a skip frame ahead of a non-designated non-inverted sheet.

16. The apparatus according to claim 15 further comprising a receiver catalog listing look up table to designate one or more designated receivers.

17. The apparatus according to claim 16 further comprising a controller to accept an operator added designation to determine the one or more designated receivers.

18. The apparatus according to claim 15 further comprising an override whereby any sheets with an image on only one side of the designated receiver are treated as a non-designated receiver and thus are treated as non-invertible.

19. The apparatus according to claim 15 whereby one or more of the images are blank.

20. The apparatus according to claim 15 whereby a controller instructs the feeder to feed one or more receiver sheet that will not be imaged using the inserter.
